(19) United States
(12) Patent Application Publication
(10) Pub. No.: US 2011/0254314 A1
(43) Pub. Date: Oct. 20, 2011

(54) Windshield attachment for a utility vehicle or the like and method of manufacture

(76) Inventor: Manuel T. Renard, Bigfoot, TX (US)

(21) Appl. No.: 13/066,491

(22) Filed: Apr. 15, 2011

Related U.S. Application Data
(60) Provisional application No. 61/342,509, filed on Apr. 15, 2010.

(51) Int. Cl. B60J 1/04; B23P 11/00

(52) U.S. Cl. 296/190.1; 296/200; 29/428

(57) ABSTRACT

The present invention relates to a fold-down windshield, wherein the fold-down windshield is suitable for use with an all-terrain vehicle. The present invention also relates to a method of manufacturing a cab for an all-terrain vehicle, wherein the method of manufacturing comprises the step of attaching a fold-down windshield to the cab.

### CROSS REFERENCE TO RELATED APPLICATIONS

This application claims priority to Provisional Application U.S. 61/342,509 filed 15 Apr. 2010

### STATEMENT REGARDING FEDERALLY SPONSORED RESEARCH OR DEVELOPMENT

Not Applicable

### REFERENCE TO SEQUENCE LISTING

Not Applicable

### BACKGROUND

Utility vehicles today, such as the Polaris Ranger or ATV (All Terrain Vehicle), or the Yamaha Rhino, are generally manufactured without an enclosed cab or windshield. Instead, these vehicles are manufactured with roll bars and an open top and front. The end user then has the option of purchasing various enclosures and tops having a windshield and perhaps a rear window or doors.

Because utility vehicles are used in a wide range of applications, including hunting and farm and ranch applications, there has been a need for windshields that can be opened up to allow access through the front, yet provide protection from the elements as needed.

Some attempts to solve this problem in the utility vehicle industry have been attempted. One windshield, for example, comprises a hydraulic mechanism that enables the driver to lift the windshield up from the closed position. This model of lift-up windshield, however, has many inherent problems. The hydraulic mechanism is susceptible to wear and breakage if the vehicle is driven while the windshield is up, which commonly occurs in a hunting or farming situation. Further, this lift-style windshield lifts in a manner such that it overhangs the front corners of some utility vehicles; this overhang increases the room required for turning the vehicle. It also exposes people walking around the vehicle to head injury due to the position and height of the windshield corners during the open position.

There are many other windshields available in the utility vehicle industry; however, all of these windshields are manufactured of a polycarbonate resin thermoplastic, or Lexan. This material is susceptible to scratching, which is undesirable both from an aesthetic and usefulness standpoint.

It is known that Jeep CJ's (Civilian Jeeps) or other military vehicles have been equipped with fold-down windshields. These windshields are manufactured of tempered glass, lending them ruggedness, but have not been adapted to use in an ATV or utility vehicle. Further, these windshields fold down only to a horizontal position; this requires that the driver exit the vehicle to strap the windshield to the front to keep it from bouncing up while driving over rough terrain or at higher speeds.

There remains a need in the industry for a windshield that will provide open access through the front of an ATV or utility vehicle that is rugged and easy to use.

### SUMMARY

The present invention relates to a fold-down windshield, wherein the fold-down windshield is suitable for use with an all-terrain vehicle.

The present invention also relates to a method of manufacturing a cab for an all-terrain vehicle, wherein the method of manufacturing comprises the step of attaching a fold-down windshield to the cab.

### BRIEF DESCRIPTION OF THE DRAWINGS

FIG. 1 is a front view of the fold-down windshield and cab as installed on an all-terrain vehicle.

FIG. 2 is a perspective view of the fold-down windshield and cab as installed on an all-terrain vehicle.

FIG. 3 is a rear perspective view of the cab as installed on an all-terrain vehicle.

FIG. 4 illustrates the male portion of one embodiment of a stop mechanism.

FIG. 5 illustrates the female portion of one embodiment of a stop mechanism.

FIG. 6 illustrates one embodiment of a lock mechanism in the locked position.

FIG. 7 illustrates one embodiment of a lock mechanism in the unlocked position.

FIG. 8 illustrates one embodiment of a cup holder.

FIG. 9 illustrates one embodiment of an equipment holder.

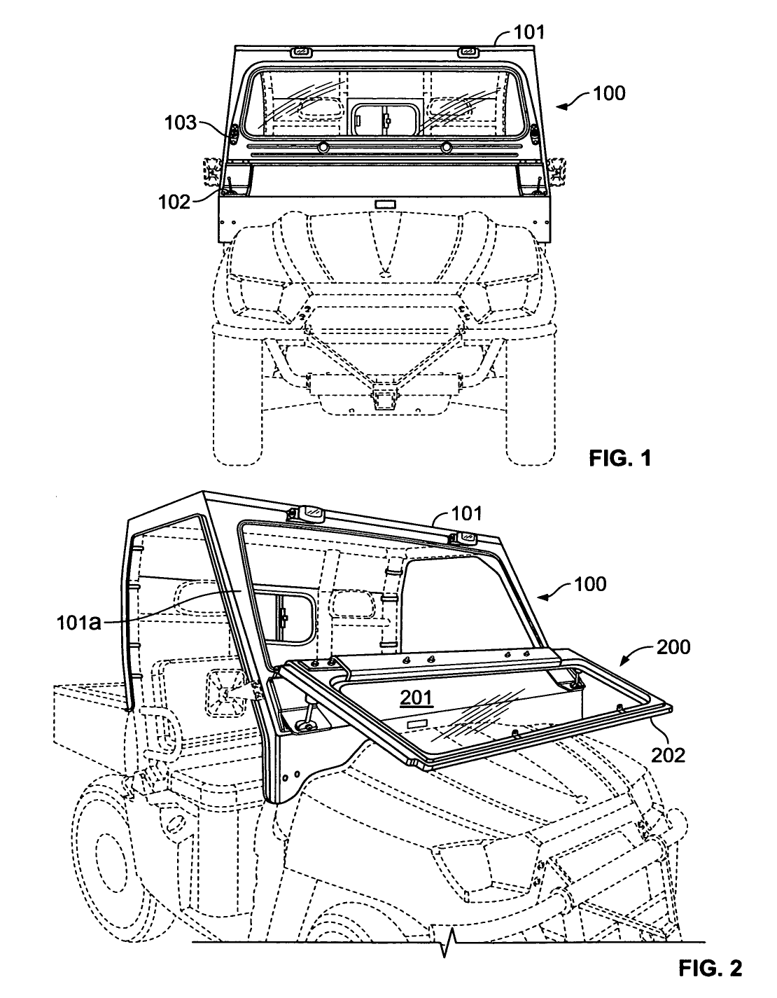

### DESCRIPTION

The present invention relates to a fold-down windshield 200 having a glass window 201 and a window frame 202, wherein the fold-down windshield 200 is suitable for use with an all-terrain vehicle.

The fold-down windshield 200 of the present invention may be part of a cab assembly 100 suitable for use with an all-terrain vehicle.

The cab assembly 100 comprises a cab 101, a fold-down windshield 200, and a hinge mechanism 105 that enables the windshield 200 to fold down to a position below the horizontal, as demonstrated in FIG. 2. Preferably, the windshield 200 can be folded down to approximately 30 to 45 degrees below the horizontal.

It is further preferred that the hinge mechanism 105 comprise a split hinge. By means of a split hinge, the owner or driver may remove the fold-down windshield 200 completely by opening the windshield 200 approximately 30 degrees from the closed position and then lifting the windshield 200 up and out of the hinge mechanism 105. This option is particularly useful in hotter seasons and/or towing, during which time the windshield 200 can be removed completely to improve fuel efficiency when not required.

It is also desirable that the owner or driver may remove the fold-down windshield 200 without the use of tools. A hinge mechanism 105 comprising a split hinge achieves this purpose.

In a preferred embodiment, a stop mechanism comprising a male protrusion 102 attached to the lower frame 101a of the cab 101 engages a female portion 103 attached to the window frame 202 provides buffering when the windshield 200 is opened abruptly and dropped. The female portion 103 of the stop mechanism preferably comprises a rubber insert 103a. When the male portion 102 engages the female portion 103, the rubber insert 103a increases the force required to lift the windshield 200, meaning the windshield 200 will not inadvertently bounce up while driving on rough terrain.

To close the fold down windshield 200, the driver, while remaining in the driver's seat, may reach out and pull the windshield 200 to the closed position. A lock mechanism is provided to retain the windshield in the closed position. In a preferred embodiment, a notched elastic strap 106a is provided, which engages a hook 10613. More than one lock mechanism may be used, and any lock mechanism suitable to exposure to the elements and rough handling are contemplated.

Optionally, the interior of the cab assembly 100 is equipped with a larger than standard cup holder 107, as illustrated in FIG. 8. Specifically, the cup holder 107 is sized to hold a 32 ounce drink, while a cup holder 107 sized for a 64 ounce drink is contemplated, particularly for hotter climates. The cup holder 107 is rugged enough to withstand rough use and to weather the elements.

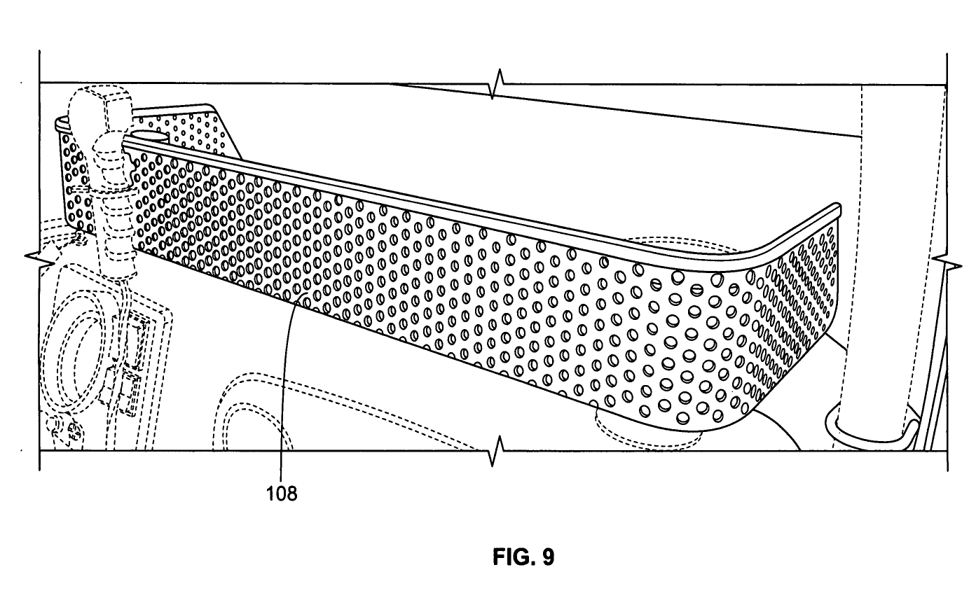

Similarly, the interior of the cab assembly 100 may be equipped with an equipment holder 108, as illustrated in FIG. 9, to provide the driver a suitable location to store equipment that must be readily accessible, in a farming situation, for example.

The cab 101 is preferably manufactured of metal, such as 14 gage steel sheetmetal, and lined with other materials to provide insulation and sealing. Rhino liner is the exterior liner of choice to seal connection points and to add some insulation properties. An interior bonding headliner may be used on the interior portion of the cap 101 to provide further insulation from the elements, heat in particular.

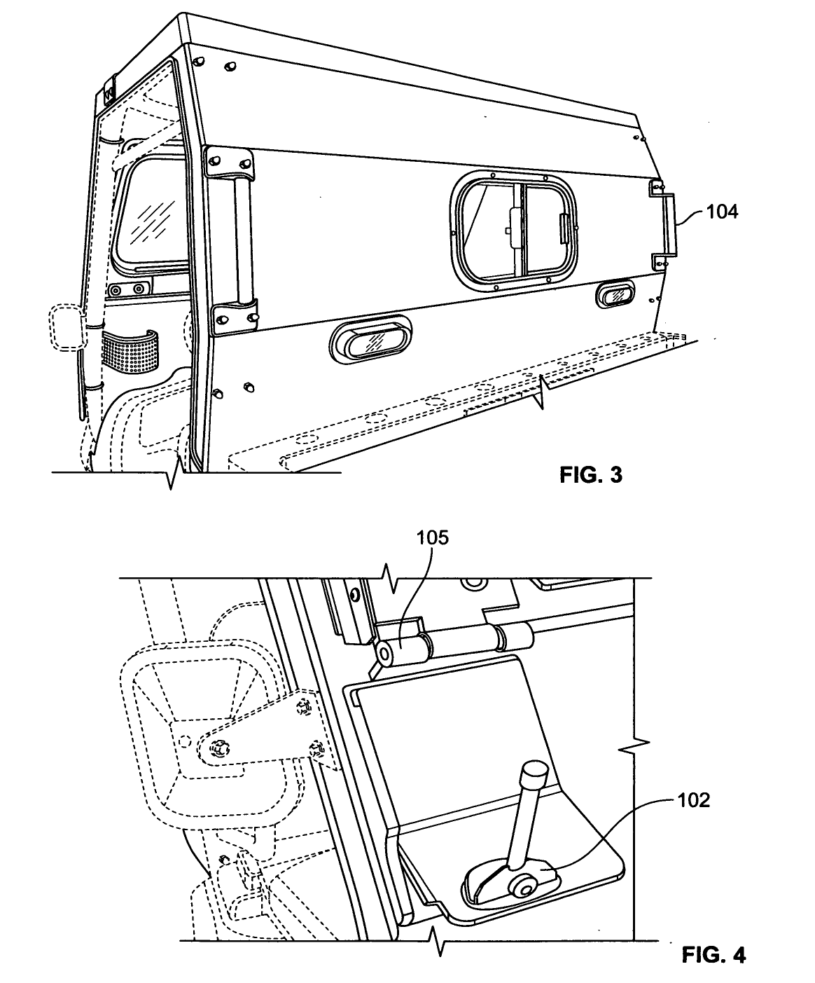

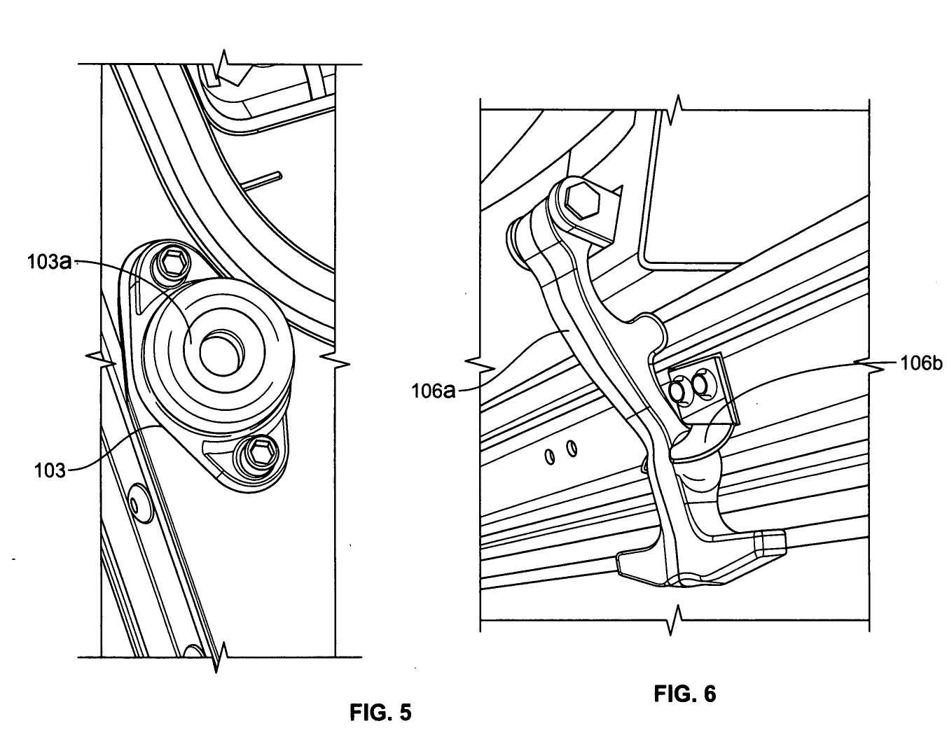

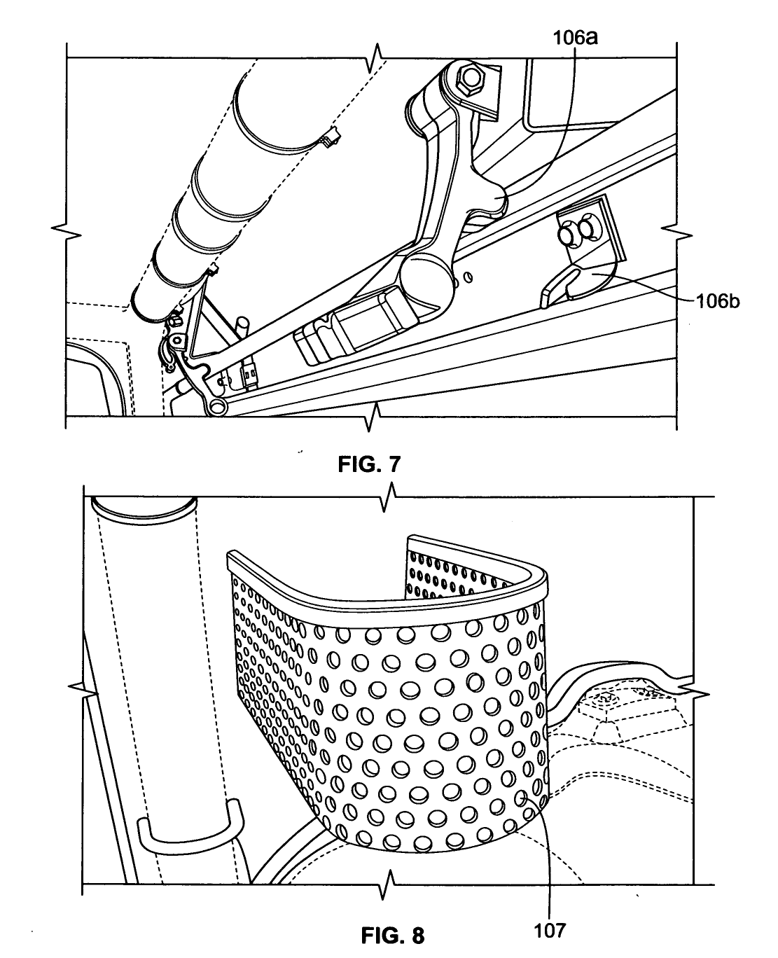

As illustrated in FIG. 3, the cab assembly 100 also preferably includes one or more handlebars 104 to ease entering and exiting the rear bed of the utility vehicle.

Further, the cab assembly 100 may be manufactured out of one or more pieces, and may be attached together and to the utility vehicle by any means known in the industry, such as bolting, welding, or the use of split collars. It is believed that providing attachment by way of split collars may give retail users the option of installing the cab top and fold-down windshield as an aftermarket and self-install option.

Other options that are contemplated with the present invention include running lights, rearview mirrors, sliding rear windows, vents, cargo lights, and dome lighting. An after-market cargo box is also contemplated.

Although not depicted in the figures, a lowering mechanism may be included, such as a strap or other extension, to allow the driver to more easily lower the window quietly, such as when hunting, without standing up in the driver's seat.

The present invention also relates to a method of manufacturing a cab assembly 100 for an all-terrain vehicle, wherein the method of manufacturing comprises the step of attaching a fold-down windshield 200 to the cab frame, preferably using a hinging mechanism 105 to enable the windshield 200 to fold down below the horizontal.

The method of manufacturing preferably includes the step of attaching a hinge mechanism 105 comprising a split hinge to the cab 101 and/or the window frame 202.

The method of manufacturing may include the step(s) of attaching by any means known in the industry, such as welding, bolting, or gluing, a female portion 103 of a stop mechanism to the windshield frame 202, and/or a male portion 102 of a stop mechanism to the lower frame 101a of the cab 101,

The method of manufacturing may include the step of attaching a lock mechanism 106a, 106b to the cab 101 and/or the window frame 202.

The method of manufacturing may include the step of attaching a cup holder 107 and/or an equipment holder 108 to the cab 101, preferably on the interior of the cab 101.

The method of manufacturing may include the steps of lining the top of the cab 101 with a Rhino liner, or lining the underside of the top with a headliner.

The method of manufacturing preferably includes the step of attaching the cab assembly 100 to an all-terrain or utility vehicle with a clearance of 2.5 cm or more between the roll bar of the vehicle and the underside of the top portion of the cab 101 to allow an aftermarket self-installation of other optional equipment, such as a gun rack.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the claims.

What is claimed is:

1. A fold-down windshield having a glass window and a window frame, wherein the fold-down windshield is suitable for use with an all-terrain vehicle.

2. A cab assembly suitable for use with an all-terrain vehicle, wherein said cab assembly comprises a cab, a fold-down windshield, and a hinge mechanism, said hinge mechanism comprising means to enable the windshield to fold down to a position below the horizontal.

3. The cab assembly of claim 2, wherein the windshield can be folded down to approximately 30 to 45 degrees below the horizontal.

4. The cab assembly of claim 2, wherein the hinge mechanism comprises a split hinge.

5. The cab assembly of claim 2, wherein the fold-down windshield is removable without the use of tools.

6. The cab assembly of claim 2, further comprising means for buffering when the windshield is opened abruptly and dropped.

7. The cab assembly of claim 2, further comprising a lock mechanism to retain the windshield in the closed position.

8. The cab assembly of claim 2, further comprising a larger than standard cup holder.

9. The cab assembly of claim 2, further comprising an equipment holder.

10. The cab assembly of claim 2, wherein the cab is manufactured of metaland lined with other materials to provide insulation and sealing.

11. The cab assembly of claim 2, further comprising at least one handlebar.

12. The cab assembly of claim 2, further comprising a lowering mechanism.

13. A method of manufacturing a cab assembly for an all-terrain vehicle, wherein the method of manufacturing comprises the step of attaching a fold-down windshield to a cab frame using a hinging mechanism.

14. The method of claim 13, wherein said hinging mechanism comprises a split hinge.

15. The method of claim 13, further comprising the step of attaching a stop mechanism.

16. The method of claim 13 further comprising the step of attaching a lock mechanism.

17. The method of claim 13, further comprising the step of attaching the cab assembly to an all-terrain or utility vehicle with a clearance of 2.5 cm or more between the roll bar of said vehicle and the underside of the top portion of the cab.
